(19) United States
(12) Patent Application Publication
(10) Pub. No.: US 2015/0314587 A1
(43) Pub. Date: Nov. 5, 2015

(54) DEVICE PRINTING INTENDED PATTERN AND METHOD THEREOF

(71) Applicant: Henghao Technology Co., Ltd., Hsinchu County (TW)

(72) Inventors: Chun Jung Chen, Hsinchu County (TW); Ching Fang Wong, Hsinchu County (TW); Chen-Chang Hsu, Hsinchu County (TW)

(21) Appl. No.: 14/475,935

(22) Filed: Sep. 3, 2014

(30) Foreign Application Priority Data
May 1, 2014 (TW) 103115736

(51) Int. Cl. B41F 9/00

(52) U.S. Cl. CPC B41F 9/00

(57) ABSTRACT

Configurations of a device that prints an intended pattern, and methods thereof are disclosed. The proposed device that prints the intended pattern includes a first roller used to print a first pattern having a first pattern direction on a printable media, wherein the first pattern direction and a first print direction have a first included angle of no larger than 50 degrees therebetween, and a second roller used to print a second pattern having a second pattern direction on the printable media, wherein the second pattern direction and a second print direction have a second included angle of no larger than 50 degrees therebetween, the first print direction and the second print direction are perpendicular to each other, and the first and the second patterns form the intended pattern.

### CROSS-REFERENCES TO RELATED APPLICATIONS

This application claims the benefits of Taiwan Patent Application Number 103115736 filed on May 1, 2014, at the Taiwan Intellectual Property Office, the disclosures of which are incorporated herein in their entirety by reference.

### FIELD OF THE INVENTION

The present invention relates to a device printing an intended pattern and methods thereof, in particular to a device including a first roller and a second roller respectively printing a first pattern and a second pattern on printable media and methods thereof.

### BACKGROUND OF THE INVENTION

In the prior art, when the gravure printing technique is used, the intended pattern is usually rotated to an angle of 10-45 degrees to avoid lack of ink transfer caused because the print direction and the pattern direction are perpendicular to each other. However, even if the pattern is rotated (as shown in FIG. 1), the printing quality of a portion of the line-segments is still influenced (as shown in FIGS. 2(a) to 2(d)). FIG. 1 is a schematic flow chart showing the use of a gravure printing method to print an intended pattern in the prior art. FIG. 1 includes step 11 and step 12, wherein step 11 is “rotating an original pattern 10 of an intended pattern to an angle of θ1”, and step 12 is “printing the intended pattern according to the indicated print direction”. FIG. 2(a) shows a result of printing an intended pattern 20 (a portion of the original pattern 10) when a pattern direction after rotation and a print direction are almost parallel to each other, and is a schematic diagram showing good printing performance. FIG. 2(b) shows a result of printing an intended pattern 30 (a portion of the original pattern 10) when a pattern direction after rotation and a print direction are almost vertical to each other, and is a schematic diagram showing poor printing performance. FIG. 2(b) shows a situation where two rows of neighboring patterns have the flaw of a short circuit. FIG. 2(c) shows a result of printing an intended pattern 40 (a portion of the original pattern 10) when the intended pattern after rotation has large area regions, and is a schematic diagram showing poor printing performance. FIG. 2(c) shows situations where there are places without printing ink in those large area regions (which could cause an open circuit in certain conditions). FIG. 2(d) shows a result of printing an intended pattern 50 (a portion of the original pattern 10) when the intended pattern after rotation has patterns with corners, and is a schematic diagram showing poor printing performance. FIG. 2(d) shows situations where those patterns with corners have ink overflows and short circuits caused by the ink overflows.

Therefore, how to avoid the results of printing an intended pattern with situations of poor printing performance of short circuits/open circuits/ink overflows at corners etc. is worthy of further research and improvement.

Keeping the drawbacks of the prior art in mind, and through the use of robust and persistent experiments and research, the applicant has finally conceived a device printing an intended pattern and methods thereof.

### SUMMARY OF THE INVENTION

It is an objective of the present invention to provide a device including a first roller and a second roller respectively printing a first pattern having a first pattern direction and a second pattern having a second pattern direction on a printable media, and methods thereof, wherein the first pattern direction and a first print direction, and the second pattern direction and a second direction respectively have a first included angle and a second included angle of no larger than 50 degrees, the first print direction and the second print direction are perpendicular to each other, and the first pattern and the second pattern form the intended pattern, to avoid the situation of short circuits/open circuits/ink overflows at corners etc. when the intended pattern is printed to improve the quality of the results of printing the intended pattern.

In accordance with the first aspect of the present invention, a method for printing an intended pattern includes: dividing the intended pattern into a first pattern having a first pattern direction and a second pattern having a second pattern direction, wherein the first pattern direction and a horizontal direction have a first included angle of no larger than 50 degrees, and the second pattern direction and a vertical direction have a second included angle of no larger than 50 degrees; printing the first pattern horizontally; and printing the second pattern vertically.

In accordance with the second aspect of the present invention, a method for printing an intended pattern includes: dividing the intended pattern into a first pattern having a first pattern direction and a second pattern having a second pattern direction; printing the first pattern in a first print direction; and printing the second pattern in a second print direction.

In accordance with the third aspect of the present invention, a method for printing an intended pattern includes: dividing the intended pattern into a first pattern and a second pattern; printing the first pattern in a horizontal direction; and printing the second pattern in a vertical direction.

In accordance with the fourth aspect of the present invention, a method for printing an intended pattern includes: dividing the intended pattern into a first pattern having a first pattern direction and a second pattern having a second pattern direction, wherein the first pattern direction and a first print direction have a first included angle of no larger than 50 degrees therebetween, the second pattern direction and a second print direction have a second included angle of no larger than 50 degrees, and the first print direction and the second print direction are perpendicular to each other; printing the first pattern in the first print direction; and printing the second pattern in the second print direction.

In accordance with the fifth aspect of the present invention, a method for printing an intended pattern includes: dividing the intended pattern into a first pattern having a first pattern direction and a second pattern having a second pattern direction, wherein the first pattern direction and a first print direction have a first included angle of no larger than 50 degrees therebetween, the second pattern direction and a second print direction have a second included angle of no larger than 50 degrees, and the first print direction and the second print direction are perpendicular to each other; printing the first pattern in the first print direction; and printing the second pattern in the second print direction.

In accordance with the sixth aspect of the present invention, a device printing an intended pattern includes a first roller used to print a first pattern having a first pattern direction on a printable media, wherein the first pattern direction and a first print direction have a first included angle of no larger than 50 degrees therebetween, and a second roller used to print a second pattern having a second pattern direction on the printable media, wherein the second pattern direction and a second print direction have a second included angle of no larger than 50 degrees therebetween, the first print direction and the second print direction are perpendicular to each other, and the first and the second patterns form the intended pattern.

### BRIEF DESCRIPTION OF THE DRAWINGS

Other objectives, advantages and the efficacy of the present invention will be described in detail below taken from the preferred embodiments with reference to the accompanying drawings, in which:

FIG. 1 is a schematic flow chart of using a gravure printing method to print an intended pattern in the prior art.

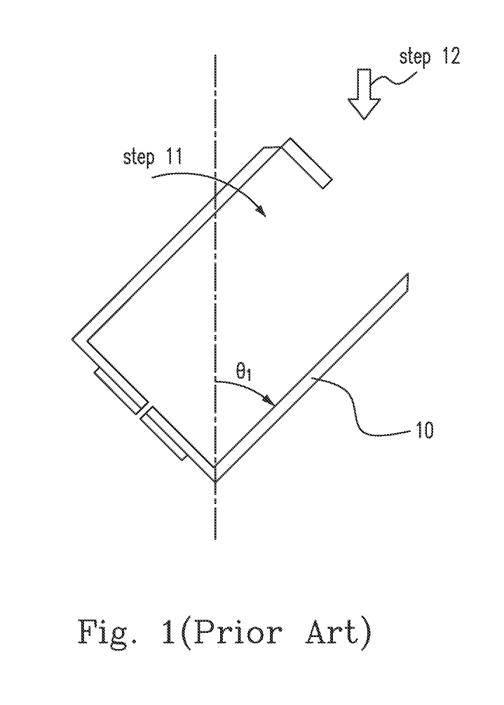

FIG. 2(a) is a schematic diagram of a result of printing an intended pattern showing good printing performance when a pattern direction after rotation and a print direction are almost parallel to each other.

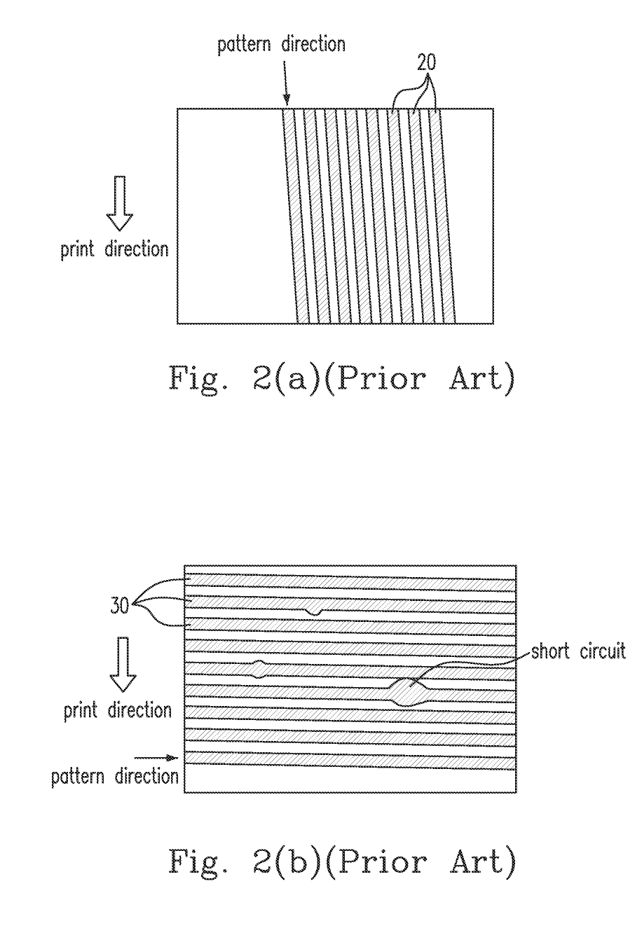

FIG. 2(b) is a schematic diagram of a result of printing an intended pattern showing poor printing performance when a pattern direction after rotation and a print direction are almost vertical to each other.

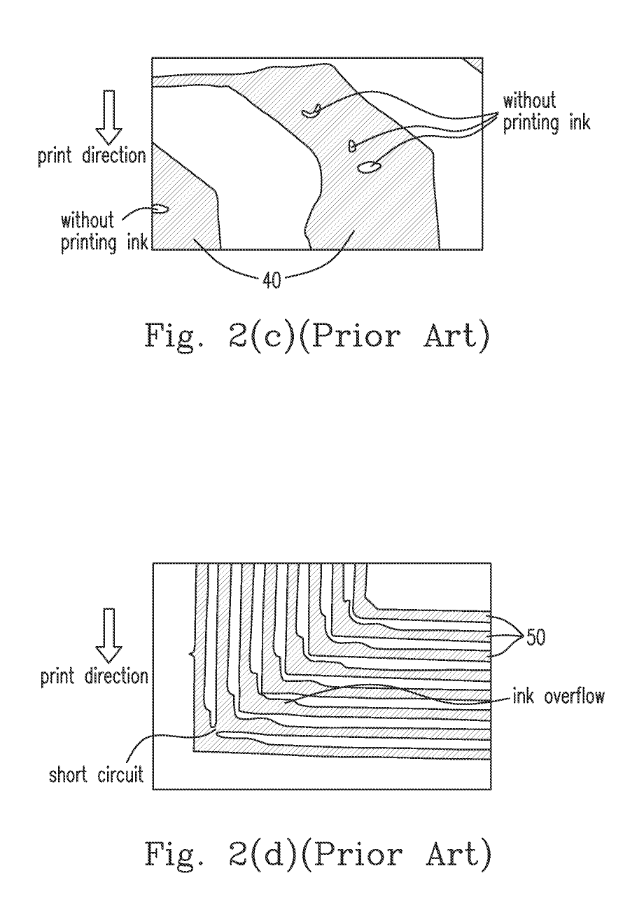

FIG. 2(c) is a schematic diagram of a result of printing an intended pattern showing poor printing performance when the intended pattern after rotation has large area regions.

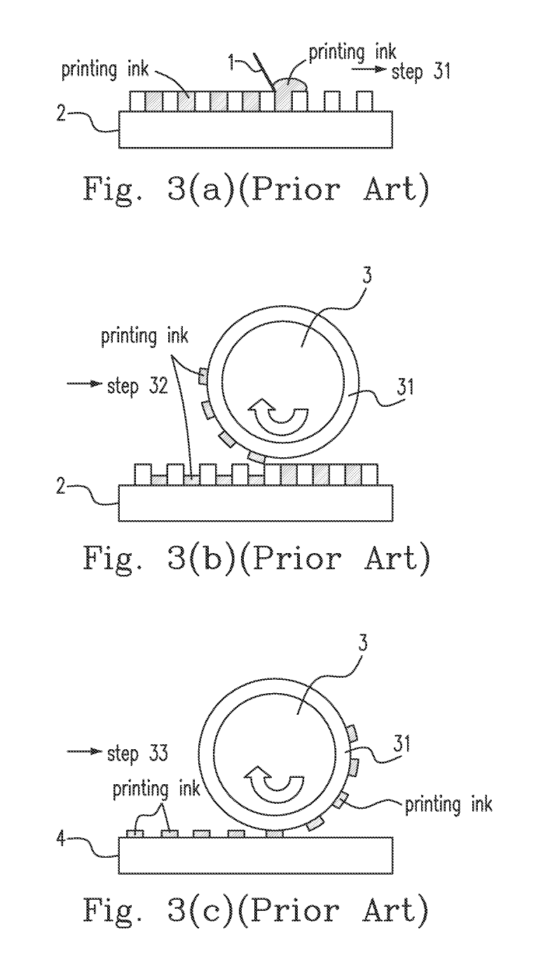

FIG. 2(d) is a schematic diagram of a result of printing an intended pattern showing poor printing performance when the intended pattern after rotation has patterns with corners.

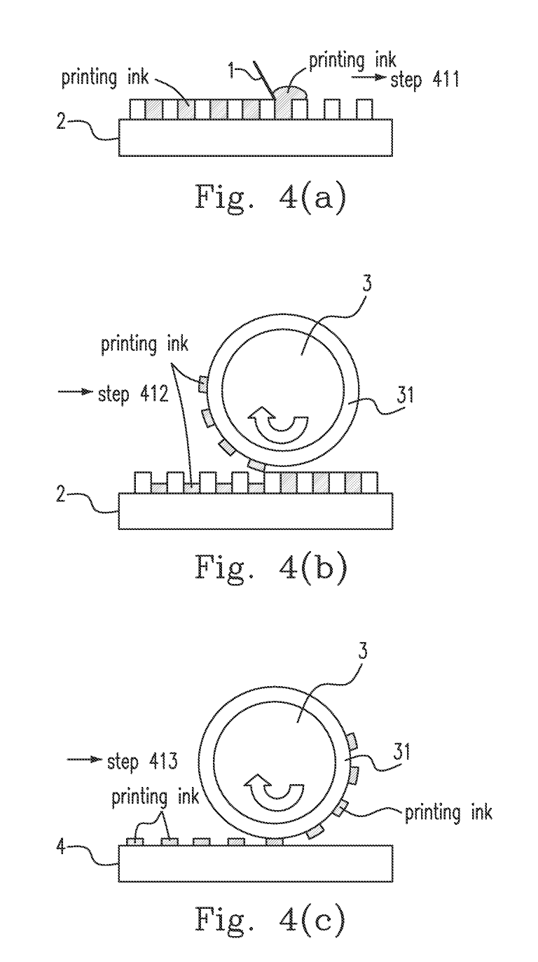

FIGS. 3(a) to 3(c) show detailed printing process flow chart of a gravure printing method used to print an intended pattern in the prior art.

FIGS. 4(a) to 4(f) show detailed printing process flow chart of a gravure printing method used to print an intended pattern according to the first preferred embodiment of the present invention.

FIGS. 5(a) to 5(c) show detailed printing process flow chart of an anastatic printing method used to print an intended pattern in the prior art.

FIGS. 6(a) to 6(f) show detailed printing process flow chart of an anastatic printing method used to print an intended pattern according to the second preferred embodiment of the present invention.

FIG. 7 is a schematic diagram of an original pattern of an intended pattern used in a gravure printing method or an anastatic printing method to print the intended pattern according to the first preferred embodiment or the second preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; they are not intended to be exhaustive or to be limited to the precise form disclosed.

According to the present invention, the gravure printing method or the anastatic printing method disclosed in the prior art, which prints only once (ink covering→ink transfer→transcription), has been changed to the proposed method to which accomplishes the printing twice. The proposed method divides the intended pattern to be printed into two patterns having two pattern directions, and the two print directions are perpendicular to each other to cause the two pattern directions to be either the same as the two print directions or to have an included angle of less than 50 degrees with the two print directions respectively. After printing twice, the final drying action is then completed.

As described above, the present invention discloses a device including a first and a second rollers, and methods thereof. This device printing an intended pattern includes a first roller used to print a first pattern on printable media, wherein a first pattern direction of the first pattern and a first print direction have a first included angle being no larger than 50 degrees, and a second roller used to print a second pattern on the printable media, wherein a second pattern direction of the second pattern and a second print direction have a second included angle being no larger than 50 degrees, the first print direction and the second print direction are perpendicular to each other, and the first and the second patterns form the intended pattern. The proposed method of using two print directions perpendicular to each other to print an intended pattern divided into a first pattern and a subsequently-printed second pattern, the preferred embodiments as follows, and similar methods all belong to the scope of the present invention. The present invention has obviously better printing results and is superior to the prior art.

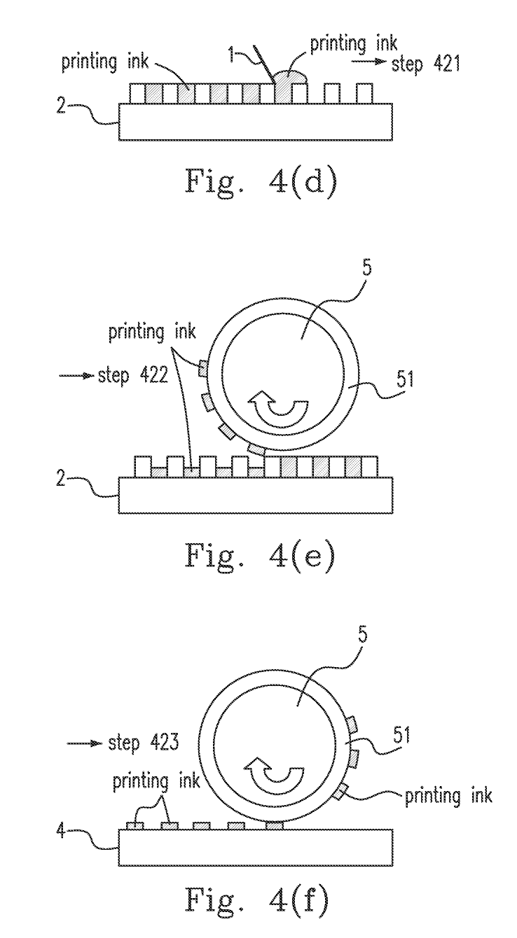

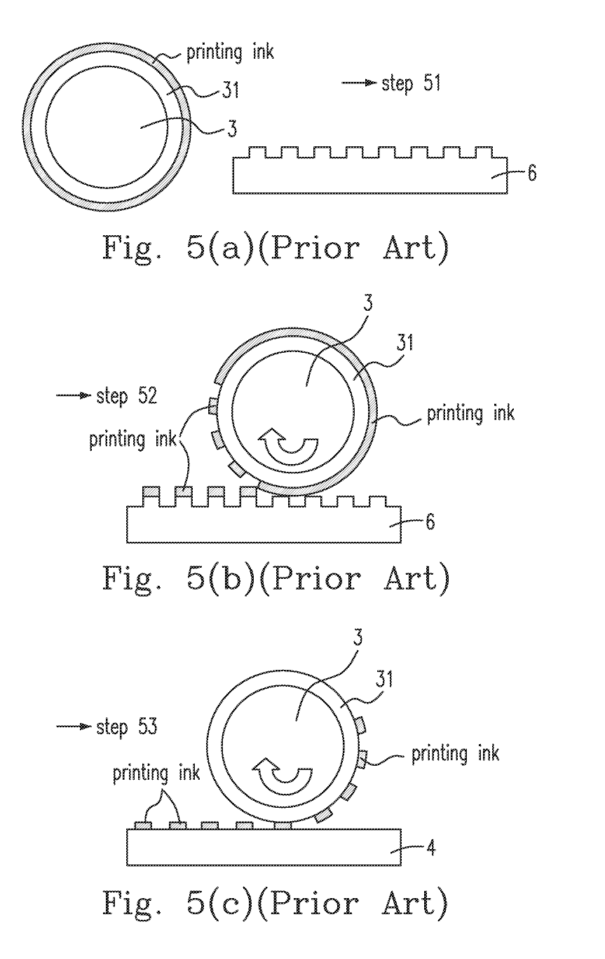

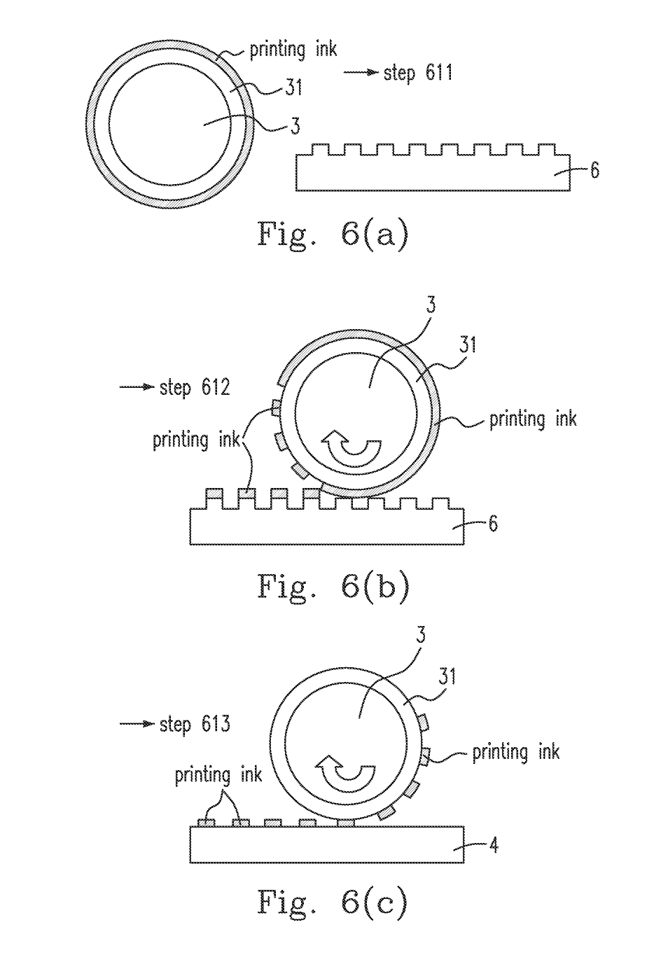

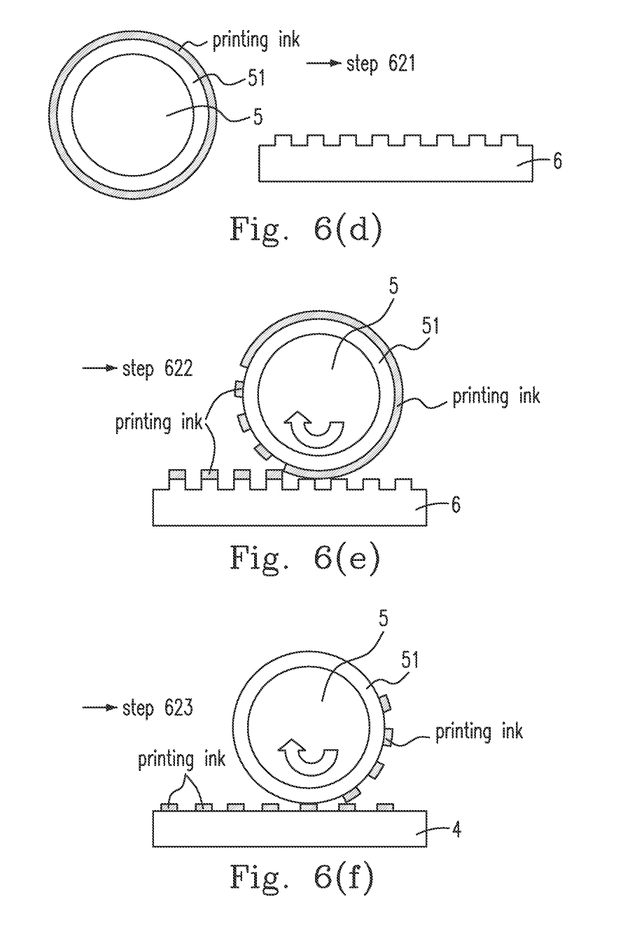

To facilitate the explanation of the present invention, a detailed printing process flow chart of a gravure printing method in the prior art as shown in FIGS. 3(a) to 3(c), a detailed printing process flow chart of a gravure printing method used to print an intended pattern according to the first preferred embodiment of the present invention as shown in FIGS. 4(a) to 4(f), a detailed printing process flow chart of an anastatic printing method in the prior art as shown in FIGS. 5(a) to 5(c), and a detailed printing process flow chart of an anastatic printing method used to print an intended pattern according to the second preferred embodiment of the present invention as shown in FIGS. 6(a) to 6(f) are enumerated as follows to highlight the differences between a device for gravure printing/anastatic printing and methods thereof in the prior art and a device for gravure printing/anastatic printing and methods thereof according to the present invention.

FIGS. 3(a) to 3(c) show a detailed printing process flow chart of a gravure printing method used to print an intended pattern in the prior art. As shown in FIGS. 3(a) to 3(c), the gravure printing device includes a scraper 1, an intaglio plate 2, and a first roller 3 including a blanket 31, and the gravure printing method includes step 31: using the scraper 1 to apply printing ink to the intaglio plate 2, and to apply a consistent amount of printing ink (as shown in FIG. 3(a)); step 32: causing the first roller 3 to roll over the intaglio plate 2 to cause the printing ink on the intaglio plate 2 to transfer to the blanket 31 (as shown in FIG. 3(b)); and step 33: causing the first roller 3 including the blanket 31 with the transferred printing ink to roll over a printable media 4 to allow the printing ink to be transferred to the printable media 4 to accomplish the printing of the intended pattern (as shown in FIG. 3(c)).

FIGS. 4(a) to 4(f) show a detailed printing process flow chart of a gravure printing method used to print an intended pattern according to the first preferred embodiment of the present invention. As shown in FIGS. 4(a) to 4(f), the gravure printing device includes a scraper 1, an intaglio plate 2, a first roller 3 including a blanket 31, and a second roller 5 including a blanket 51, and the gravure printing method includes step 411: using the scraper 1 to put printing ink onto the intaglio plate 2, and to apply a consistent amount of printing ink (as shown in FIG. 4(a)); step 412: causing the first roller 3 to roll over the intaglio plate 2 to cause the printing ink on the intaglio plate 2 to be transferred to the blanket 31 (as shown in FIG. 4(b)); step 413: causing the first roller 3 including the blanket 31 with the transferred printing ink to roll over a printable media 4 to cause the printing ink to be transferred to the printable media 4 to accomplish the printing of a first pattern (as shown in FIG. 4(c)); step 421: using the scraper 1 to put printing ink onto the intaglio plate 2, and to apply a consistent amount of printing ink again (as shown in FIG. 4(d)); step 422: causing the second roller 5 to roll over the intaglio plate 2 to cause the printing ink on the intaglio plate 2 to be transferred to the blanket 51 (as shown in FIG. 4(e)); step 423: causing the second roller 5 including the blanket 51 with the transferred printing ink to roll over the printable media 4 to allow the printing ink to be transferred to the printable media 4 to accomplish the printing of a second pattern (as shown in FIG. 4(f)), wherein the combination of the first pattern and the second pattern form the intended pattern.

FIGS. 5(a) to 5(c) show a detailed printing process flow chart of an anastatic printing method used to print an intended pattern in the prior art. As shown in FIGS. 5(a) to 5(c), the anastatic printing device includes a relief printing plate 6, and a first roller 3 including a blanket 31, and the anastatic printing method includes step 51: coating printing ink on the blanket 31 of the first roller 3 (as shown in FIG. 5(a)); step 52: causing the first roller 3 to roll over the relief printing plate 6 to allow a portion of the printing ink on the blanket 31 of the first roller 3 to be removed and transferred to the relief printing plate 6 (as shown in FIG. 5(b)); and step 53: causing the first roller 3 including the blanket 31 with the other portion of the transferred printing ink to roll over a printable media 4 to allow the printing ink to be transferred to the printable media 4 to accomplish the printing of the intended pattern (as shown in FIG. 5(c)).

FIGS. 6(a) to 6(f) show a detailed printing process flow chart of an anastatic printing method used to print an intended pattern according to the second preferred embodiment of the present invention. As shown in FIGS. 6(a) to 6(f), the anastatic printing device includes a relief printing plate 6, a first roller 3 including a blanket 31, and a second roller 5 including a blanket 51, and the anastatic printing method includes step 611: coating printing ink on the blanket 31 of the first roller 3 (as shown in FIG. 6(a)); step 612: causing the first roller 3 to roll over the relief printing plate 6 to cause a portion of the printing ink on the blanket 31 of the first roller 3 to be removed and transferred to the relief printing plate 6 (as shown in FIG. 6(b)); and step 613: causing the first roller 3 including the blanket 31 with the other portion of the transferred printing ink to roll over a printable media 4 to cause the printing ink to be transferred to the printable media 4 to complete the printing of a first pattern (as shown in FIG. 6(c)); step 621: coating printing ink on the blanket 51 of the second roller 5 (as shown in FIG. 6(d)); step 622: causing the second roller 5 to roll over the relief printing plate 6 to cause a portion of the printing ink on the blanket 51 of the second roller 5 to be removed and transferred to the relief printing plate 6 (as shown in FIG. 6(e)); and step 623: causing the second roller 5 including the blanket 51 with the other portion of the attached printing ink to roll over the printable media 4 to cause the printing ink to be transferred to the printable media 4 to complete the printing of a second pattern (as shown in FIG. 6(f)), wherein the combination of the first pattern and the second pattern form the intended pattern.

Certainly, the first roller 3 and the second roller 5 as shown in FIGS. 4(a)-4(f) and FIGS. 6(a)-6(f) can also be the same roller, and when the device only has one roller (3/5) including a blanket (31/51), the roller including the blanket prints the first pattern and then the second pattern.

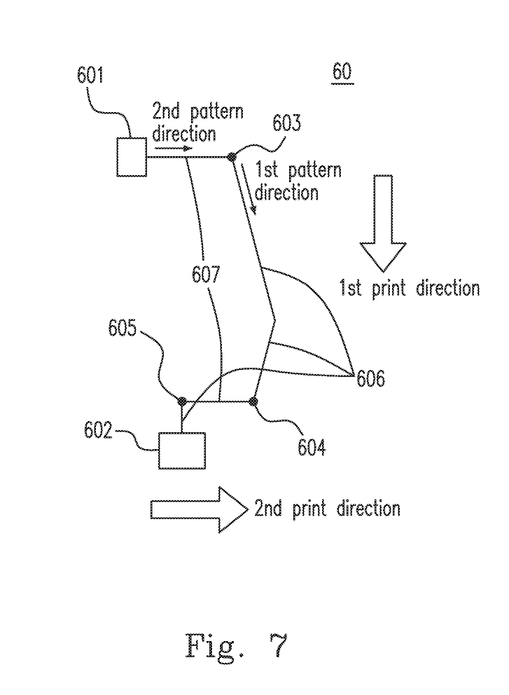

FIG. 7 shows a schematic diagram of an original pattern of an intended pattern used in a gravure printing method or an anastatic printing method to print the intended pattern according to the first preferred embodiment or the second preferred embodiment of the present invention. In FIG. 7, the original pattern 60 of the intended pattern includes a first pattern 606 and a second pattern 607, wherein the first pattern 606 includes a first pattern direction having an included angle of ≦50 degrees in the first print direction (this can be further limited to an included angle of ≦45 degrees, if necessary), and the second pattern 607 includes a second pattern direction having an included angle of ≦50 degrees in the second print direction (this can be further limited to an included angle of ≦45 degrees also, if necessary). As for connection points 603, 604 and 605, they belong to not only the first pattern, but also the second pattern because they are located at the junctions of the first pattern and the second pattern. After the first and the second printings, each of these connection points 603, 604 and 605 is printed twice and has a printed ink thickness greater than that of those places printed only once so as to have relatively better conductivity when applied to the printing of a printed circuit board (PCB), and clearly distinct colors due to the relatively thicker printed ink thickness when applied to printing colored patterns. Regarding large area regions 601 and 602, they are specific regions having a width larger than 200 um (the width can be further limited to 300 um, if necessary), these large area regions 601 and 602 can be assigned to either the first pattern 606, or the second pattern 607 so as to be printed only once. Certainly, they can also be assigned to not only the first pattern, but also the second pattern such that each of the large area regions 606 and 607 is printed twice so that these regions have a relatively thicker printed ink thickness than those places printed only once so as to relatively improve the conductivity when applied to the printing of a PCB, and will have clearly distinct colors due to the relatively thicker printed ink thickness when applied to printing colored patterns.

### Embodiments

1. A method for printing an intended pattern, comprising:

dividing the intended pattern into a first pattern having a first pattern direction and a second pattern having a second pattern direction, wherein the first pattern direction and a horizontal direction have a first included angle of no larger than 50 degrees, and the second pattern direction and a vertical direction have a second included angle of no larger than 50 degrees;

printing the first pattern horizontally; and

printing the second pattern vertically.

2. The method according to Embodiment 1, being one of a gravure printing method and an anastatic printing method, wherein the printing the first pattern step has a first print direction the same as the horizontal direction, and the printing the second pattern step has a second print direction the same as the vertical direction.

3. The method according to Embodiment 1 or 2, wherein the first included angle is no larger than 45 degrees, the second included angle is no larger than 45 degrees, and the intended pattern is one of a printed pattern of a conductive material and a color printed pattern.

4. The method according to any one of the above-mentioned Embodiments, wherein one of the first pattern and the second pattern includes at least one large area region of a width larger than 200 um, a selected one of the at least one large area region is printed with both the printing the first pattern step and the printing the second pattern step, and an unselected one in the at least one large area region is printed only with one of the printing the first pattern step and the printing the second pattern step.

5. The method according to any one of the above-mentioned Embodiments, wherein the width is larger than 300 um.

6. The method according to any one of the above-mentioned Embodiments, wherein the first pattern has a first printed ink thickness, the second pattern has a second printed ink thickness, the selected one has a third printed ink thickness, and the third printed ink thickness is thicker than either of the first printed ink thickness and the second printed ink thickness.

7. The method according to any one of the above-mentioned Embodiments, wherein the first pattern and the second pattern intersect at a connection point, the connection point is printed by the printing the first pattern step and the printing the second pattern step.

8. The method according to any one of the above-mentioned Embodiments, wherein the first pattern has a first printed ink thickness, the second pattern has a second printed ink thickness, the connection point has a third printed ink thickness, and the third printed ink thickness is thicker than either of the first printed ink thickness and the second printed ink thickness.

9. A method for printing an intended pattern, comprising:

dividing the intended pattern into a first pattern having a first pattern direction and a second pattern having a second pattern direction;

printing the first pattern in a first print direction; and

printing the second pattern in a second print direction.

10. The method according to Embodiment 9, wherein the first pattern direction and the first print direction have a first included angle of no larger than 45 degrees therebetween, the second pattern direction and the second print direction have a second included angle of no larger than 45 degrees therebetween, one of the first pattern and the second pattern has a large area region of a width larger than 300 um, the first pattern and the second pattern have a connection point, one of the first pattern and the second pattern have a selected large area region, and the connection point and the selected large area region are printed by both the printing the first pattern step and the printing the second pattern step.

11. A method for printing an intended pattern, comprising:

dividing the intended pattern into a first pattern and a second pattern;

printing the first pattern in a horizontal direction; and

printing the second pattern in a vertical direction.

12. The method according to Embodiment 11, wherein the first pattern has a first pattern direction, the second pattern has a second pattern direction, the first pattern direction and the horizontal direction have a first included angle of no larger than 45 degrees therebetween, and the second pattern direction and the vertical direction have a second included angle of no larger than 45 degrees therebetween.

13. A method for printing an intended pattern, comprising:

dividing the intended pattern into a first pattern having a first pattern direction and a second pattern having a second pattern direction, wherein the first pattern direction and a first print direction have a first included angle of no larger than 50 degrees therebetween, the second pattern direction and a second print direction have a second included angle of no larger than 50 degrees, and the first print direction and the second print direction are perpendicular to each other;

printing the first pattern in the first print direction; and

printing the second pattern in the second print direction.

14. A device printing an intended pattern, comprising:

a first roller used to print a first pattern having a first pattern direction on a printable media, wherein the first pattern direction and a first print direction have a first included angle of no larger than 50 degrees therebetween, and

a second roller used to print a second pattern having a second pattern direction on the printable media, wherein the second pattern direction and a second print direction have a second included angle of no larger than 50 degrees therebetween, the first print direction and the second print direction are perpendicular to each other, and the first and the second patterns form the intended pattern.

15. The device according to Embodiment 14, wherein the first roller and the second roller are the same roller.

16. The device according to Embodiment 14 or 15, being used in one of a gravure printing method and an anastatic printing method, wherein when the device is used for the gravure printing method, the device further includes an intaglio plate and a scraper used to put a printing ink onto the intaglio plate, and when the device is used for the anastatic printing method, the device further includes a relief printing plate.

According to the aforementioned descriptions, the present invention discloses a device including a first roller and a second roller respectively printing a first pattern having a first pattern direction and a second pattern having a second pattern direction on a printable media, and methods thereof, wherein the first pattern direction and a first print direction, and the second pattern direction and a second direction respectively have a first included angle and a second included angle of no larger than 50 degrees, the first print direction and the second print direction are perpendicular to each other, and the first pattern and the second pattern form the intended pattern, to avoid the situation of short circuits/open circuits/ink overflows at corners etc. when the intended pattern is printed to improve the quality of the results of printing the intended pattern, and thus is non-obvious and has novelty.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. A method for printing an intended pattern, comprising:
dividing the intended pattern into a first pattern having a first pattern direction and a second pattern having a second pattern direction, wherein the first pattern direction and a horizontal direction have a first included angle of no larger than 50 degrees, and the second pattern direction and a vertical direction have a second included angle of no larger than 50 degrees;
printing the first pattern horizontally; and
printing the second pattern vertically.

2. The method according to claim 1, being one of a gravure printing method and anastatic printing method, wherein the printing the first pattern step has a first print direction the same as the horizontal direction, and the printing the second pattern step has a second print direction the same as the vertical direction.

3. The method according to claim 1, wherein the first included angle is no larger than 45 degrees, the second included angle is no larger than 45 degrees, and the intended pattern is one of a printed pattern of a conductive material and a color printed pattern.

4. The method according to claim 1, wherein one of the first pattern and the second pattern includes at least one large area region of a width larger than 200 um, a selected one of the at least one large area region is printed with both the printing the first pattern step and the printing the second pattern step, and an unselected one in the at least one large area region is printed only with one of the printing the first pattern step and the printing the second pattern step.

5. The method according to claim 4, wherein the width is larger than 300 um.

6. The method according to claim 4, wherein the first pattern has a first printed ink thickness, the second pattern has a second printed ink thickness, the selected one has a third printed ink thickness, and the third printed ink thickness is thicker than either of the first printed ink thickness and the second printed ink thickness.

7. The method according to claim 1, wherein the first pattern and the second pattern intersect at a connection point, the connection point is printed by the printing the first pattern step and the printing the second pattern step.

8. The method according to claim 7, wherein the first pattern has a first printed ink thickness, the second pattern has a second printed ink thickness, the connection point has a third printed ink thickness, and the third printed ink thickness is thicker than either of the first printed ink thickness and the second printed ink thickness.

9. A method for printing an intended pattern, comprising:
dividing the intended pattern into a first pattern having a first pattern direction and a second pattern having a second pattern direction;
printing the first pattern in a first print direction; and
printing the second pattern in a second print direction.

10. The method according to claim 9, wherein the first pattern direction and the first print direction have a first included angle of no larger than 45 degrees therebetween, the second pattern direction and the second print direction have a second included angle of no larger than 45 degrees therebetween, one of the first pattern and the second pattern has a large area region of a width larger than 300 um, the first pattern and the second pattern have a connection point, one of the first pattern and the second pattern have a selected large area region, and either of the connection point and the selected large area region are printed by both the printing the first pattern step and the printing the second pattern step.

11. A method for printing an intended pattern, comprising:
dividing the intended pattern into a first pattern and a second pattern;
printing the first pattern in a horizontal direction; and
printing the second pattern in a vertical direction.

12. The method according to claim 11, wherein the first pattern has a first pattern direction, the second pattern has a second pattern direction, the first pattern direction and the horizontal direction have a first included angle of no larger than 45 degrees therebetween, and the second pattern direction and the vertical direction have a second included angle of no larger than 45 degrees therebetween.

13. A method for printing an intended pattern, comprising:
dividing the intended pattern into a first pattern having a first pattern direction and a second pattern having a second pattern direction, wherein the first pattern direction and a first print direction have a first included angle of no larger than 50 degrees therebetween, the second pattern direction and a second print direction have a second included angle of no larger than 50 degrees, and the first print direction and the second print direction are perpendicular to each other;
printing the first pattern in the first print direction; and
printing the second pattern in the second print direction.

14. A device printing an intended pattern, comprising:
a first roller used to print a first pattern having a first pattern direction on a printable media, wherein the first pattern direction and a first print direction have a first included angle of no larger than 50 degrees therebetween, and
a second roller used to print a second pattern having a second pattern direction on the printable media, wherein the second pattern direction and a second print direction have a second included angle of no larger than 50 degrees therebetween, the first print direction and the second print direction are perpendicular to each other, and the first and the second patterns form the intended pattern.

15. The device according to claim 14, wherein the first roller and the second roller are the same roller.

16. The device according to claim 14, being used in one of a gravure printing method and an anastatic printing method, wherein when the device is used for the gravure printing method, the device further includes an intaglio plate and a scraper used to put a printing ink onto the intaglio plate, and when the device is used for the anastatic printing method, the device further includes a relief printing plate.
